(19) United States
(12) Patent Application Publication
(10) Pub. No.: US 2026/0029262 A1
(43) Pub. Date: Jan. 29, 2026

(54) MAGNETIC-INDUCTIVE FLOW METER

(71) Applicant: Endress+Hauser Flowtec AG, Reinach (CH)

(72) Inventors: Oliver Graf, Känerkinden (CH); Raphael Hess, Reinach (CH)

(21) Appl. No.: 18/995,630

(22) PCT Filed: Jun. 5, 2023
(86) PCT No.: PCT/EP2023/064980

§ 371 Date: Jan. 16, 2025

(30) Foreign Application Priority Data
Jul. 26, 2022 (DE) 10 2022 118 729.2

(51) Int. Cl. G01F 1/58

(52) U.S. Cl. CPC G01F 1/584; G01F 1/586

(57) ABSTRACT

A magnetic-inductive flow meter for determining a flow rate-dependent measurement variable includes: a measuring tube for guiding a flowable medium, the measuring tube having an electrically conductive carrier tube, the carrier tube having a first electrode opening; a magnetic field-generating device for generating a magnetic field penetrating the measuring tube, the magnetic field generating device being arranged on an outer lateral surface of the measuring tube; a first electrode arrangement, the first electrode arrangement being arranged in the first electrode opening; and a first electrode cap interlockingly and/or force-fittingly arranged on the first electrode arrangement and designed to prevent the formation of a moisture bridge between the first electrode arrangement and the carrier tube.

The invention relates to a magnetic-inductive flow meter.

Magnetic-inductive flow meters are used for determining the flow rate and the volumetric flow of a flowing medium in a pipeline. A magnetic-inductive flow meter has a magnetic field-generating device that generates a magnetic field perpendicular to the flow direction of the flowing medium. Single coils are typically used for this purpose. In order to realize a predominantly homogeneous magnetic field, pole shoes are additionally formed and attached such that the magnetic field lines run over the entire pipe cross-section substantially perpendicularly to the transverse axis or in parallel to the vertical axis of the measuring pipe. In addition, a magnetic-inductive flow meter has a measuring tube on which the magnetic field-generating device is arranged. A measurement electrode pair, which is attached to the lateral surface of the measuring tube or arranged within the electrode openings in the measuring tube, taps an electrical measurement voltage or potential difference which is applied perpendicularly to the flow direction and to the magnetic field and occurs when a conductive medium flows through the applied magnetic field in the flow direction. Since, according to Faraday's law of induction, the tapped measurement voltage depends upon the rate of the flowing medium, the flow rate and, with the inclusion of a known tube cross-section, the volumetric flow can be determined from the induced measurement voltage that is measured.

Magnetic-inductive flow meters are often used in process and automation engineering for fluids, starting from an electrical conductivity of approximately 5 μS/cm. Corresponding flow meters are sold by the applicant in a wide variety of embodiments for various fields of application-for example, under the name PROMAG.

Installing the measuring electrodes in the openings provided in the wall of the measuring tube of the magnetic-inductive flow meter is currently a relatively time-consuming and thus costly process. The installation time is approximately one hour. One reason for this is the elaborate sealing of the measuring electrode required to prevent the formation of moisture bridges. The known installation method has the following steps: the measuring electrode is inserted into the bore, sealed against the measuring tube, and suitably secured in the bore. For sealing and insulation purposes, a potting mold is temporarily affixed to the outer surface of the measuring tube in the area of the measuring electrode. The potting mold is removed again after the curing process of the potting compound. To achieve sufficient sealing, a release agent, such as a grease, is applied between the contact surface of the curing mold and the outer surface of the measuring tube. The dimensions of the potting mold are adapted to the specific application. The liquid potting compound is poured into the potting mold. The curing process is accelerated by supplying heat. For this purpose, heating sleeves are wrapped around the potting mold. Once the potting compound has cured, the potting mold is removed, the measuring tube is rotated by 180°, and the previously mentioned method steps are repeated to mount the second measuring electrode.

DE 10 2007 009 050 A1 discloses an alternative method for installing a measuring electrode in a magnetic-inductive flow meter. For this purpose, the measuring electrode is positioned in a measuring electrode opening, a potting mold is arranged on the outer surface of the measuring tube and around the shaft of the measuring electrode, and a potting compound is introduced into the potting mold. The potting mold is removed after the potting compound has cured. The disadvantage of the disclosed solution is that it is still very costly and time-consuming.

The object of the invention is to remedy this problem.

The object is achieved by the magnetic-inductive flow meter according to claim 1.

The magnetic-inductive flow meter according to the invention for determining a flow rate-dependent measurement variable comprises:

a measuring tube for guiding a flowable medium,
wherein the measuring tube has an electrically conductive carrier tube,
wherein the carrier tube has a first electrode opening;
   a magnetic field-generating device for generating a magnetic field that penetrates the measuring tube,
wherein the magnetic field-generating device is arranged on an outer lateral surface of the measuring tube;
   a first electrode arrangement,
wherein the first electrode arrangement is arranged in the first electrode opening; and
   a first electrode cap, which is interlockingly and/or force-fittingly arranged on the first electrode arrangement and is designed to prevent the formation of a moisture bridge between the first electrode arrangement and the carrier tube.

In the magnetic-inductive flow meter, moisture can form on any component surface due to pressure and temperature differences if these surfaces do not have water-repellent properties. In order to prevent a moisture bridge from forming between the metallic carrier tube and the electrode arrangement for tapping an induced measuring voltage and thus disrupting the determination of the flow rate-dependent measurement variable, such moisture bridges must be eliminated.

A conventional process for partially potting the electrode arrangements typically requires a processing time of 2 hours per magnetic-inductive flowmeter. The reusable potting molds must be laboriously cleaned after each process. The solution to the problem lies in positioning an electrode cap over the electrode arrangement, thus acting as a protective cap. Using a cap eliminates the labor-intensive potting process and thus shortens the manufacturing time of the magnetic-inductive flow meter.

Advantageous embodiments of the invention are the subject matter of the dependent claims.

One embodiment provides that the first electrode arrangement comprise an electrode body,
wherein the electrode body has an electrode head,
wherein the electrode body has an electrode shaft, in particular an electrode shaft provided with a thread,
   wherein the first electrode cap is interlockingly or force-fittingly connected to the electrode shaft.

The advantage of this embodiment is that the electrode cap is easier to mount. A force-fitting and/or interlocking connection with the carrier tube-as disclosed, for example, in DE 10 2007 009 050 A1 for the potting mold—or even an integral bond with the carrier tube is very laborious to assemble. In contrast, an interlocking and/or force-fitting connection of the first electrode cap can be intuitively implemented by the installer without requiring additional preparation.

One embodiment provides that the first electrode cap comprise an electrode shaft receptacle, in particular designed as a blind hole, into which the electrode shaft extends.

One embodiment provides that a diameter of the electrode shaft holder be undersized relative to a diameter of the electrode shaft.

This offers the advantage that the electrode cap can press into the thread of the electrode shaft, thus further improving the fastening of the first electrode cap.

One embodiment provides that the first electrode cap delimit an inner volume containing air and the electrode shaft.

According to the invention, the first electrode cap is not to be interpreted as a potting mold.

According to the invention, no potting material is provided that extends around a section of the first electrode arrangement and protects it against moisture and the formation of moisture bridges.

The first electrode cap replaces the conventional potting material.

One embodiment provides that the first electrode arrangement comprise an insulating body,
wherein at least a section of the insulating body is designed to be hydrophobic in order to prevent the formation of moisture bridges between the first electrode arrangement and the carrier tube,
wherein the insulating body encloses the electrode shaft at least in sections.

One embodiment provides that the first electrode cap be interlockingly and/or force-fittingly connected to the insulating body.

This results in an improved fixation of the first electrode cap to the first electrode arrangement.

One embodiment provides for the magnetic-inductive flow meter to comprise:

a measuring circuit for determining the flow rate-dependent measurement variable based upon a measuring signal tapped by means of the first electrode arrangement,
wherein the first electrode arrangement is in electrical communication with the measuring circuit via a signal cable,
wherein the first electrode cap has a signal cable opening through which the signal cable extends.

The signal cable opening is dimensioned in such a way that, preferably, no moisture enters the inner volume of the first electrode cap.

One embodiment provides that the first electrode arrangement comprise an electrode body,
wherein the first electrode arrangement comprises a sleeve for centering the electrode body in the first electrode opening,
wherein at least a section of the sleeve is designed to be hydrophilic.

Due to the hydrophilic design of the sleeve, moisture will preferentially accumulate there. Since the first electrode cap radially encloses the sleeve, the formation of moisture bridges can be reduced.

One embodiment provides for the magnetic-inductive flow meter to comprise:

a second electrode arrangement,
wherein the carrier tube has a second electrode opening,
wherein the second electrode arrangement is positioned in the second electrode opening,
wherein the first electrode arrangement and the second electrode arrangement are electrically connected via an electrode bridge;
   a first electrode cap, which is interlockingly and/or force-fittingly arranged on the second electrode arrangement and is designed to prevent the formation of a moisture bridge between the second electrode arrangement and the carrier tube,
wherein the first electrode cap and the second electrode cap each have an electrode bridge opening through which the electrode bridge extends.

The electrical connection of electrode arrangements that are located on one side of the measuring tube has the advantage that the measurement of the flow rate-dependent measurement variable is less sensitive to asymmetries in the flow profile. The asymmetries are typically caused by disturbances on the inlet side. In the context of the patent application, reference is made to DE 10 2018 108 197 A1 in its entirety, in which the principle underlying the electrically short-circuited measuring electrodes or electrode arrangements is explained.

One embodiment provides that the electrode bridge comprise a flat connector tab and a flat plug,
wherein the flat plug is electrically connected, via the flat connector tab, to the electrode body of the first electrode arrangement,
wherein the electrode bridge opening of the first electrode arrangement is designed such that the flat connector tab can be passed through it.

The embodiment has the effect of significantly simplifying the installation and connection of the electrode arrangements, thereby reducing the time required for installation.

One embodiment provides that the signal cable opening, in particular a diameter of the signal cable opening, be undersized relative to the signal cable, in particular relative to a diameter of the signal cable, and/or the electrode bridge opening, in particular a diameter of the electrode bridge opening, be undersized relative to the electrode bridge, in particular relative to a diameter of the electrode bridge.

This results in an improved fastening of the first electrode cap and/or the second electrode cap and ensures that moisture cannot penetrate at all, or only in non-critical quantities.

One embodiment provides that an inner diameter of the first electrode cap be undersized relative to an outer diameter of the insulating body.

This results in an improved fixation of the first electrode cap to the first electrode arrangement or to the insulating body.

One embodiment provides that the first electrode cap and/or the second electrode cap exhibit, at least in sections, a ductility of at least 100%, in particular at least 250% and preferably 500%.

This has the advantage that the signal cable and/or the electrode bridge can be more easily passed through the corresponding opening.

One embodiment provides that the first electrode cap and/or the second electrode cap be formed from an injection-moldable sealing material, in particular comprising an elastomer, which is suitable for protection against the ingress of moisture.

Choosing the appropriate material for the first electrode cap and/or the second electrode cap can further improve the prevention of moisture bridge formation. This is particularly advantageous if liquids have entered the housing.

One embodiment provides that the first electrode cap be formed, at least in sections, from at least one of the following listed materials:
silicone,
synthetic rubber,
closed-cell foam,
latex,
thermoplastic polyurethane,
thermoplastic polyethylene,
rubber.

One embodiment provides that the measuring tube have a nominal diameter of DN350 and larger.

Especially in the case of magnetic-inductive flow meters with measuring tubes having nominal diameters larger than DN350, the housing is not fully encapsulated. However, this means that the electrodes are no longer protected against moisture bridging to the carrier tube, and, instead, they must be individually and labor-intensively potted.

The invention is explained in greater detail with reference to the following figures. In the drawings:

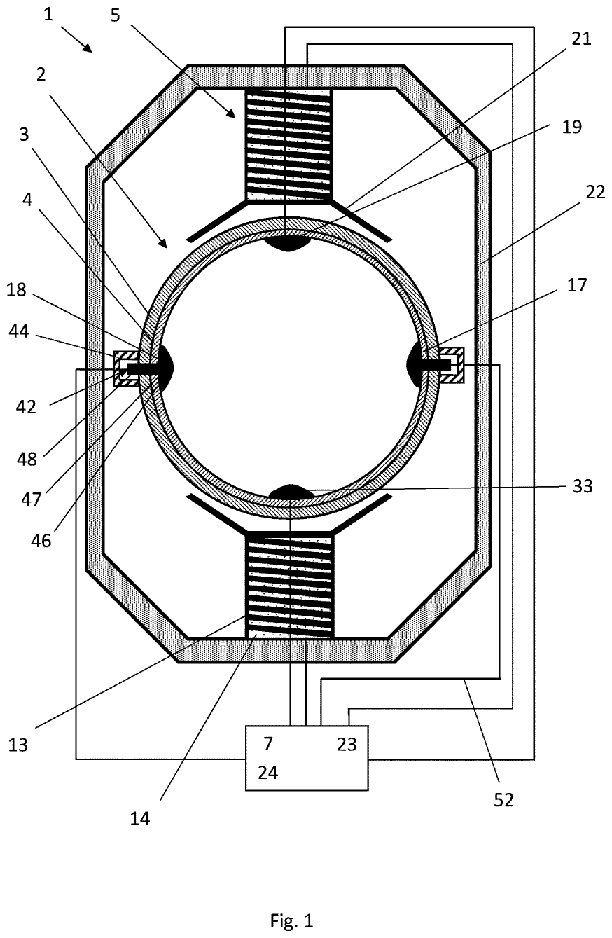

FIG. 1 shows a cross-section through a magnetic-inductive flow meter;

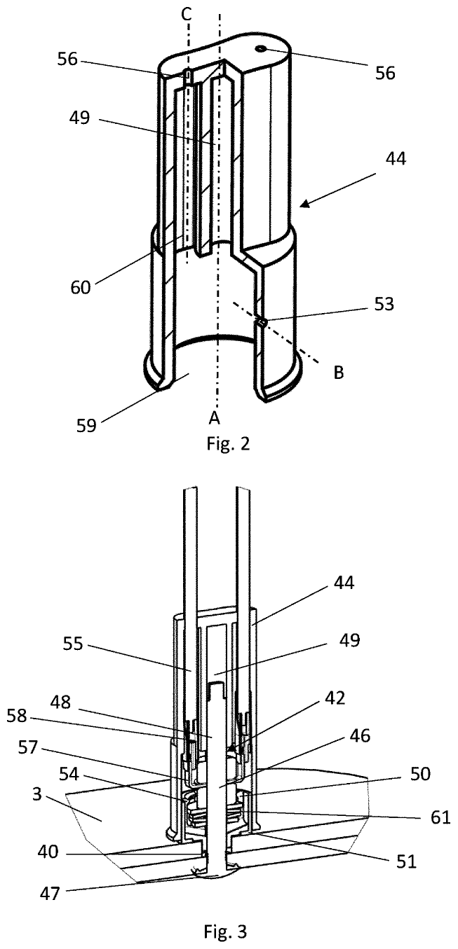

FIG. 2 shows a partially sectioned view of an embodiment of the first electrode cap;

FIG. 3 shows a cross-section through a first electrode arrangement and a first electrode cap;

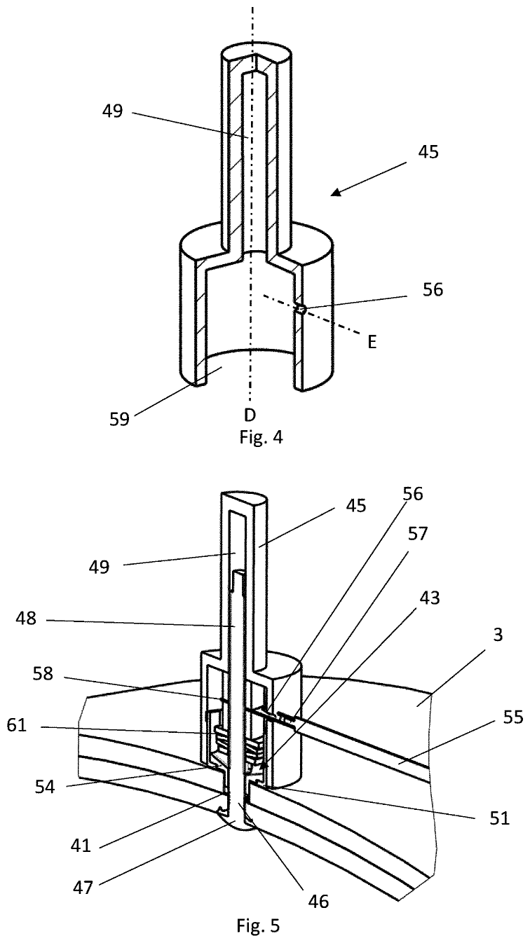

FIG. 4 shows a partially sectioned view of an embodiment of the second electrode cap;

FIG. 5 shows a cross-section through a second electrode arrangement and a second electrode cap;

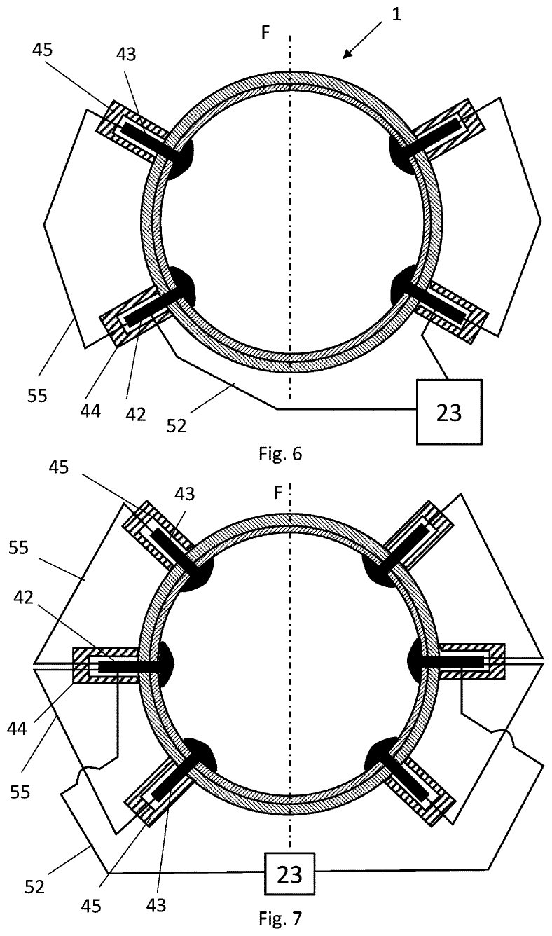

FIG. 6 shows a cross-section through a further embodiment of the magnetic-inductive flow meter; and

FIG. 7 shows a cross-section through a further embodiment of the magnetic-inductive flow meter.

FIG. 1 shows a cross-section through a magnetic-inductive flow meter 1. The structure and measuring principle of a magnetic-inductive flow meter 1 are known in principle. A flowable medium having a sufficiently high electrical conductivity is conducted through a measuring tube 2. The measuring tube 2 comprises a carrier tube 3, which is typically made of, or at least comprises, steel, ceramic, plastic, or glass. Especially when metallic support tubes 3 are used, moisture bridges can form between the measuring electrode 18, 19 and the carrier tube 3, leading to undesirable short circuits. To prevent the dissipation of the measurement voltage induced in the medium via the carrier tube 3, the inner wall is lined with an insulating material, such as a (plastic) liner 4 or ceramic tiles.

A magnetic field-generating device 5 is arranged on carrier tube 3 in such a way that the magnetic field lines are oriented substantially perpendicularly to a longitudinal direction defined by the measuring tube axis. The magnetic field-generating device 5 generally comprises at least one saddle coil or at least one coil 13 with a coil core 14. The magnetic field-generating device 5 further comprises at least one pole shoe 21, which is arranged at one end of the coil core 14. The pole shoe 21 can be a separate component or can be monolithically connected to the coil core 14. In the embodiment shown in FIG. 1, the magnetic-inductive flow meter 1 has two diametrically arranged coils 13, each having a coil core 14 and a pole shoe 21. The two coil cores 14 are connected to one another, in particular magnetically, via a field return 22. The field return 22 connects the opposing sides of the coil cores 14 to each other. However, magneto-inductive flow meters 1 with exactly one coil 13 having exactly one coil core 14 and without a field return 22 are also known. Furthermore, magnetic-inductive flow meters 1 having saddle coils in which no coil core is arranged are also known. The coil 13 is connected to an operating circuit 7 which drives the coil 13 with an operating signal. The operating signal can be a voltage with a time-variable curve and is characterized by operating signal parameters, wherein at least one of the operating signal parameters is controllable. The magnetic field generated by the device 5 for producing the magnetic field is produced using a pulsed direct current of alternating polarity provided by an operating circuit 7. This ensures a stable zero point and makes the measurement insensitive to influences due to electrochemical disturbances. The two coils 13 can be connected separately to the operating circuit 7 or connected in series or parallel to one another.

When the magnetic field is applied, a flow-dependent potential distribution results in the measuring tube 2, which potential distribution can be detected, for example, in the form of an induced measurement voltage. A device for tapping the induced measurement voltage is arranged on the measuring tube 2. In the embodiment shown, the device for tapping the induced measurement voltage is formed by two oppositely arranged measurement electrodes 17, 18, which establish a galvanic contact with the medium and are each arranged in respective electrode openings. However, magnetic-inductive flow meters 1 are also known which comprise measurement electrodes 17, 18, arranged on the outer wall of the carrier tube 3, that are not in contact with a medium. The measurement electrodes 17, 18 are generally arranged diametrically and form an electrode axis, or are intersected by a transverse axis which runs perpendicularly to the magnetic field lines and the longitudinal axis of the measuring tube 2. However, devices for tapping the induced measurement voltage and having more than two measurement electrodes are also known (see FIGS. 6 and 7). The flow-rate-dependent measurement variable can be determined on the basis of the measured measurement voltage. The flow-rate-dependent measurement variable comprises the flow rate, the volume flow, and/or the mass flow of the medium. A measurement circuit 7 is configured to detect the induced measurement voltage applied to the measurement electrodes 17, 18. An evaluation circuit 24 is configured to determine the flow rate-dependent measurement variable based upon the measured measuring voltage. The measuring electrodes 17, 18 illustrated are shown only in simplified form. Generally, the measuring electrode 17, 18 consists of an electrode arrangement 42, comprising an electrode body 46 with an electrode head 47 and an electrode shaft 48, an insulating body in the form of an insulating sleeve 51, a (snap-on) sleeve for centering the electrode body 46, and at least one fastening means for securing the electrode body 46 in the electrode opening. The electrode body 46 is electrically conductive. Typically, electrode bodies 46 made of steel, tantalum, or titanium are used. The first electrode arrangement 42 is in electrical communication with the measuring circuit 23 via a signal cable 52. The signal cable 52 can, for example, be a coaxial cable. In this case, the first electrode cap 44 has a signal cable opening (not shown in FIG. 1, but depicted in FIG. 2) through which the signal cable 52 extends.

Commercially available magnetic-inductive flow meters have two further electrodes in addition to the measuring electrodes 17, 18. In the first case, a fill-level monitoring electrode 19 optimally attached at the highest point in the measuring tube 2 serves to detect partial filling of the measuring tube 2 and is configured to pass this information to the user and/or to take into account the fill level when determining the volume flow. Additionally, a reference electrode 33, which is usually attached diametrically to the fill-level monitoring electrode 19 or at the lowest point of the measuring tube cross-section, serves to establish a controlled electric potential in the medium. Generally, the reference electrode 33 is used to connect the flowing medium to a ground potential.

The operating circuit 7, measuring circuit 23, and evaluation circuit 24 can be part of a single electronic circuit or can form individual circuits.

According to the invention, the magnetic-inductive flowmeter comprises a first electrode cap 44 for each measuring electrode 17, 18 or first electrode arrangement 44 located on one side of the measuring tube. The first electrode cap 44 is interlockingly or force-fittingly arranged on the first electrode arrangement 42 and is designed to prevent the formation of a moisture bridge between the first electrode arrangement 42 and the carrier tube 3. Details of the first electrode cap 44 and its arrangement on the measuring tube 2 are shown in FIGS. 2 and 3.

FIG. 2 shows a partially sectioned view of an embodiment of the first electrode cap 44. The substantially hollow-cylindrical first electrode cap 44 can be interlockingly and/or force-fittingly arranged on a first electrode arrangement and is designed to prevent the formation of a moisture bridge between the first electrode arrangement and the electrically conductive carrier tube. The first electrode cap 44 has an electrode shaft receptacle 49, designed as a blind hole in FIG. 2, into which the electrode shaft of the first electrode arrangement extends after the first electrode cap 44 is attached to the first electrode arrangement. The diameter of the electrode shaft receptacle 49 is undersized relative to a diameter of the electrode shaft in order to achieve an improved fastening of the first electrode cap 44 to the first electrode arrangement. The first electrode cap 44 can also be interlockingly and/or force-fittingly connected to an insulating body (not shown) of the first electrode arrangement 42. For this purpose, the first electrode cap 44, in a fastening region with the insulating body, has an inner diameter which is undersized relative to an outer diameter of the insulating body.

Furthermore, the illustrated first electrode cap 44 has exactly one signal cable opening 53 through which a signal cable 52 for connecting the first electrode arrangement 42 to a measuring circuit can be passed. The signal cable opening 53 is designed to allow a cable lug attached to the signal cable 52 to pass through. The signal cable opening 53 is positioned in a lateral surface of the first electrode cap 44. A signal cable opening longitudinal axis B lies in a cross-sectional plane of the first electrode cap or intersects a first electrode cap longitudinal axis A perpendicularly.

In addition, the first electrode cap 44 has at least one electrode bridge opening 56 through which an electrode bridge, such as a cable or wire, can be passed in order to electrically connect two electrode arrangements. In the embodiment shown, the first electrode cap 44 has exactly two electrode bridge openings 56, through each of which an electrode bridge can be passed. In addition, the electrode bridge opening 56 is designed to also allow a flat connector tab of the electrode bridge to pass through. For this purpose, the first electrode cap 44 exhibits, at least in sections, a ductility of at least 100%, in particular at least 250% and preferably 500%. The first electrode cap 44 is formed from an injection-moldable sealing material, in particular comprising an elastomer, which is suitable for protection against the ingress of moisture. The electrode bridge opening 56 is positioned in a front surface of the first electrode cap 44. An electrode bridge opening longitudinal axis C runs parallel to the electrode cap longitudinal axis A. Opposite the front surface, an electrode cap opening 59 is provided for receiving the first electrode arrangement, allowing the first electrode arrangement to be passed through it. Following the electrode bridge opening 56, an electrode bridge guide 60 is disposed, along which the electrode bridge can be guided to the electrode arrangement.

Silicone, synthetic rubber, closed-cell foam, thermoplastic polyurethane, thermoplastic polyethylene, rubber, and/or latex have proven to be suitable materials.

In identical or modified form, the illustrated first electrode cap 44 is also suitable as a second electrode cap. The main difference between the first electrode cap 44 and the second electrode cap is that the second electrode cap does not have a signal cable opening. In one embodiment, the second electrode cap also has exactly one electrode bridge opening, whereas the number of electrode bridge openings of the first electrode cap 44 corresponds to the number of further second electrode arrangements arranged on the same side of the carrier tube. The second electrode cap can be interlockingly or force-fittingly arranged on the second electrode arrangement and is designed to prevent the formation of a moisture bridge between the second electrode arrangement and the carrier tube. It has, in particular, one electrode bridge opening through which an electrode bridge can be passed.

FIG. 3 shows a cross-section through a first electrode arrangement 42 with the first electrode cap 44 arranged in FIG. 2. The first electrode arrangement 42 is arranged in a first electrode opening 40. Furthermore, the first electrode arrangement 42 comprises an electrode body 46, which has an electrode head 47 and an electrode shaft 48 which is provided, in particular, with a thread. The electrode head 47 is in contact with the medium when medium is present in the measuring tube. The first electrode cap 44 is interlockingly and/or force-fittingly connected to the electrode shaft 48 in that the electrode shaft 48 extends into the electrode shaft receptacle 49. In this case, a diameter of the electrode shaft holder 49 is undersized relative to a diameter of the electrode shaft 48.

The first electrode cap 44 and the outer support tube wall delimit an inner volume 50 containing air and at least the electrode shaft 48. According to the invention, the inner volume 50 is designed to be without potting.

The first electrode arrangement 42 comprises an insulating body 51 at least a section of which is designed to be partially hydrophobic. The insulating body 51 serves to prevent moisture bridging between the first electrode arrangement 42 and the carrier tube 3. The insulating body 51 is designed as a cylindrical sleeve and encloses the electrode shaft 48 at least in sections. To ensure adequate fastening of the first electrode cap 44 to the first electrode arrangement 42, the first electrode cap 44 is interlockingly and/or force-fittingly connected to the insulating body 51.

Furthermore, the first electrode arrangement 42 comprises a (snap-on) sleeve 54 for centering the electrode body 46 in the first electrode opening 40. The sleeve 54 comprises a disc spring 61, which is designed to relax or tighten in response to mechanical movements of the liner caused by temperature changes. At least a section of the sleeve 54 is designed to be hydrophilic. There is therefore a risk that moisture will accumulate on the sleeve 54 and form a water film. The purpose of the first electrode cap 44 is to prevent this.

The illustrated electrode bridge 55 has a flat plug 58 and a flat connector tab 57, via which the flat plug 58 is electrically connected to the electrode body 46, in particular the electrode body 46 of the first electrode arrangement 42. The electrode bridge opening 56 is designed such that the flat plug 58 can be passed through it. If the flat connector tab 57 cannot be connected separately to the flat plug 58, the electrode bridge opening 56 is designed such that the flat connector tab 57 can be passed through it.

FIG. 4 shows a partially sectioned view of an embodiment of the second electrode cap 45. The substantially hollow-cylindrical second electrode cap 45 can be interlockingly and/or force-fittingly attached to a second electrode arrangement 43 and is designed to prevent the formation of a moisture bridge between the second electrode arrangement and the electrically conductive carrier tube. The second electrode cap 45 has an electrode shaft receptacle 49, designed as a blind hole in FIG. 4, into which the electrode shaft of the second electrode arrangement extends after the second electrode cap 45 is attached to the second electrode arrangement. The diameter of the electrode shaft receptacle 49 is undersized relative to a diameter of the electrode shaft in order to achieve an improved fastening of the second electrode cap 45 to the second electrode arrangement. The second electrode cap 45 can also be interlockingly and/or force-fittingly connected to an insulating body (not shown) of the second electrode arrangement. For this purpose, the second electrode cap 45 has, in a fastening region in which the second electrode cap 45 is in contact with the insulating body, an inner diameter which is undersized relative to an outer diameter of the insulating body.

Furthermore, the illustrated second electrode cap 45—unlike the first electrode cap—has no signal cable opening. The second electrode cap 45 has at least one electrode bridge opening 56 through which an electrode bridge, such as a cable, a wire, or a sheet metal part, can be passed in order to electrically connect two electrode arrangements. An example of a sheet metal part is described in DE 10 2018 116 400 A1. In the embodiment shown, the second electrode cap 45 has exactly one electrode bridge opening 56 through which at least one, in particular exactly one, electrode bridge can be passed. In addition, the electrode bridge opening 56 is designed to also allow a flat connector tab of the electrode bridge to pass through. For this purpose, the second electrode cap 45 exhibits, at least in sections, a ductility of at least 100%, in particular at least 250% and preferably 500%. The second electrode cap 45 is formed from an injection-moldable sealing material, in particular comprising an elastomer, which is suitable for protection against the ingress of moisture. The electrode bridge opening 56 is arranged in a lateral surface of the second electrode cap 45. An electrode bridge opening longitudinal axis E lies in an electrode cap cross-section and intersects the electrode cap longitudinal axis D, in particular perpendicularly. The second electrode cap 45 has an electrode cap opening 59 for receiving the second electrode arrangement, allowing the second electrode arrangement to be passed through it.

Silicone, synthetic rubber, closed-cell foam, thermoplastic polyurethane, thermoplastic polyethylene, rubber, and/or latex have proven to be suitable materials.

FIG. 5 shows a cross-section through a second electrode arrangement and the second electrode cap from FIG. 4. The second electrode arrangement 43 is arranged in a second electrode opening 41. Furthermore, the second electrode arrangement 43 comprises an electrode body 46, which has an electrode head 47 and an electrode shaft 48 which is provided, in particular, with a thread. The electrode head 47 is in contact with the medium when medium is present in the measuring tube. The second electrode cap 45 is interlockingly and/or force-fittingly connected to the electrode shaft 48 in that the electrode shaft 48 extends into the electrode shaft receptacle 49. In this case, a diameter of the electrode shaft holder 49 is undersized relative to a diameter of the electrode shaft 48.

The second electrode arrangement 43 also has an insulating body 51, at least a section of which is designed to be hydrophobic. The insulating body 51 serves to prevent moisture bridge formation between the second electrode arrangement 43 and the carrier tube 3. The insulating body 51 is designed as a cylindrical sleeve and encloses the electrode shaft 48 at least in sections. To ensure adequate fastening of the second electrode cap 45 to the second electrode arrangement 43, the first electrode cap 44 is interlockingly and/or force-fittingly connected to the insulating body 51.

Furthermore, the second electrode arrangement 43 comprises a (snap-on) sleeve 54 for centering the electrode body 46 in the second electrode opening 41. The sleeve 54 comprises a disc spring 61, which is designed to relax or tighten in response to mechanical movements of the liner caused by temperature changes. At least a section of the sleeve 54 is designed to be hydrophilic. There is therefore a risk that moisture will accumulate on the sleeve 54 and form a water film. The purpose of the second electrode cap 45 is to prevent this.

The illustrated electrode bridge 55 has a flat plug 58 and a flat connector tab 57, via which the flat plug 58 is electrically connected to the electrode body 46, in particular the electrode body 46 of the second electrode arrangement 43. The electrode bridge opening 56 is designed such that the flat plug 58 can be passed through it. If the flat connector tab 57 cannot be connected separately to the flat plug 58, the electrode bridge opening 56 is designed such that the flat connector tab 57 can be passed through it.

FIG. 6 shows a cross-section through a further embodiment of the magnetic-inductive flow meter 1 having a first electrode arrangement 42 in combination with a first electrode cap 44 according to FIG. 2 and a second electrode arrangement 43 in combination with a second electrode cap 45 according to FIG. 4. The first electrode cap 44 and the second electrode cap 45 each have an electrode bridge opening through which an electrode bridge 55 extends and via which the first electrode arrangement 42 and the second electrode arrangement 43 are electrically connected. The described arrangement of the first electrode arrangement 42 and the second electrode arrangement 43 is mirrored on the opposite side of the measuring tube, in particular substantially on a longitudinal plane F. The first two electrode arrangements 42 are each connected to the measuring circuit 23 via a signal cable 52. For this purpose, the first electrode caps 44 each have a signal cable opening 53.

FIG. 7 shows a cross-section through a further embodiment of the magnetic-inductive flow meter 1 having a first electrode arrangement 42 in combination with a first electrode cap 44 according to FIG. 2 and two second electrode arrangements 43 in combination with a second electrode cap 45 in each case according to FIG. 4. The first electrode cap 44 has two electrode bridge openings. The two second electrode caps 45 each have an electrode bridge opening through which an electrode bridge 55 extends and via which the first electrode arrangement 42 is electrically connected to the corresponding second electrode arrangement 43. The described arrangement of the first electrode arrangement 42 and the second electrode arrangement 43 is mirrored on the opposite side of the measuring tube, in particular substantially on a longitudinal plane F. The first two electrode arrangements 42 are each connected to the measuring circuit 23 via a signal cable 52. For this purpose, the first two electrode caps 44 each have a signal cable opening 53.

Alternatively, one of the two second electrode caps 45 can have two electrode bridge openings, in each of which an electrode bridge 55 is arranged and which, correspondingly, are electrically connected, via an electrode bridge 55, to the first electrode arrangement 42 and the second electrode arrangement 43.

Alternatively, more than the two or three electrode arrangements can also be provided on one side of the measuring tube. These would each be configured in accordance with the electrode arrangements shown in FIG. 6 and/or FIG. 7.

### LIST OF REFERENCE SIGNS

Magnetic-inductive flow meter 1
Measuring tube 2
Carrier tube 3
Liner 4
Magnetic field-generating device 5
Operating circuit 7
Controller circuit 10
Coil 13
Coil core 14
Measurement electrode 17, 18
Fill-level monitoring electrode 19
Pole shoe 21
Field return 22
Measuring circuit 23
Evaluation circuit 24
Reference electrode 33
First electrode opening 40
Second electrode opening 41
First electrode arrangement 42
Second electrode arrangement 43
First electrode cap 44
Second electrode cap 45
Electrode body 46
Electrode head 47
Electrode shaft 48
Electrode shaft holder 49
Internal volume 50
Insulating body 51
Signal cable 52
Signal cable opening 53
Sleeve 54
Electrode bridge 55
Electrode bridge opening 56
Flat connector tab 57
Flat plug 58
Electrode cap opening 59
Electrode bridge guide 60
Disc spring 61
Thread 62

1-15. (canceled)

16. A magnetic-inductive flow meter for determining a flow rate-dependent measurement variable, comprising:
a measuring tube configured to guide a flowable medium,
wherein the measuring tube includes an electrically conductive carrier tube,
wherein the carrier tube includes a first electrode opening;
a magnetic field-generating device configured to generate a magnetic field that penetrates the measuring tube,
wherein the magnetic field-generating device is arranged on an outer lateral surface of the measuring tube;
a first electrode arrangement,
wherein the first electrode arrangement is arranged in the first electrode opening; and
a first electrode cap which is interlockingly and/or force-fittingly arranged on the first electrode arrangement and configured to prevent formation of a moisture bridge between the first electrode arrangement and the carrier tube.

17. The magnetic-inductive flow meter according to claim 16,
wherein the first electrode arrangement includes an electrode body,
wherein the electrode body includes an electrode head,
wherein the electrode body includes an electrode shaft
wherein the first electrode cap is interlockingly and/or force-fittingly connected to the electrode shaft.

18. The magnetic-inductive flow meter according to claim 17,
wherein the first electrode cap includes an electrode shaft receptacle into which the electrode shaft extends.

19. The magnetic-inductive flow meter according to claim 18,
wherein a diameter of the electrode shaft receptacle is undersized relative to a diameter of the electrode shaft.

20. The magnetic-inductive flow meter according to claim 17,
wherein the first electrode cap delimits an inner volume containing air and the electrode shaft.

21. The magnetic-inductive flow meter according to claim 16,
wherein the first electrode arrangement includes an insulating body,
wherein at least a section of the insulating body is hydrophobic as to prevent the formation of moisture bridges between the first electrode arrangement and the carrier tube,
wherein the insulating body encloses the electrode shaft at least in sections.

22. The magnetic-inductive flow meter according to claim 21,
wherein the first electrode cap is interlockingly and/or force-fittingly connected to the insulating body.

23. The magnetic-inductive flow meter according claim 16, comprising:
a measuring circuit configured to determine the flow rate-dependent measurement variable based upon a measuring signal tapped by the first electrode arrangement,
wherein the first electrode arrangement is in electrical communication with the measuring circuit via a signal cable,
wherein the first electrode cap includes a signal cable opening through which the signal cable extends.

24. The magnetic-inductive flow meter according to claim 16,
wherein the first electrode arrangement includes an electrode body,
wherein the first electrode arrangement includes a sleeve for centering the electrode body in the first electrode opening,
wherein at least a section of the sleeve is hydrophilic.

25. The magnetic-inductive flow meter according to claim 21,
wherein an inner diameter of the first electrode cap is undersized relative to an outer diameter of the insulating body.

26. The magnetic-inductive flow meter according to claim 23, comprising:
a second electrode arrangement,
wherein the carrier tube includes a second electrode opening,
wherein the second electrode arrangement is arranged in the second electrode opening,
wherein the first electrode arrangement and the second electrode arrangement are electrically connected via an electrode bridge;
a second electrode cap which is interlockingly and/or force-fittingly arranged on the second electrode arrangement and configured to prevent formation of a moisture bridge between the second electrode arrangement and the carrier tube,
wherein the first electrode cap and the second electrode cap each include an electrode bridge opening through which the electrode bridge extends.

27. The magnetic-inductive flow meter according to claim 26,
wherein the electrode bridge comprises a flat connector tab and a flat plug,
wherein the flat plug is electrically connected to the electrode body of the first electrode arrangement via the flat connector tab,
wherein the electrode bridge opening of the first electrode arrangement is configured such that the flat plug can be passed therethrough.

28. The magnetic-inductive flow meter according to claim 27,
wherein the signal cable opening is undersized relative to the signal cable and/or the electrode bridge opening is undersized relative to the electrode bridge.

29. The magnetic-inductive flow meter according to claim 26,
wherein the first electrode cap and/or the second electrode cap exhibits, at least in sections, a ductility of at least 100%.

30. The magnetic-inductive flow meter according to claim 26,
wherein the first electrode cap and/or the second electrode cap is formed from an injection-moldable sealing material that is suitable for protection against the ingress of moisture.

31. The magnetic-inductive flow meter according to claim 26, wherein the first electrode cap and/or the second electrode cap exhibits, at least in sections, a ductility of at least 500%.

32. The magnetic-inductive flow meter according to claim 28, wherein a diameter of the signal cable opening is undersized relative to a diameter of a signal cable, and/or a diameter of the electrode bridge opening is undersized relative to a diameter of the electrode bridge.

33. The magnetic-inductive flow meter according to claim 18, wherein the electrode shaft receptacle is embodied as a blind hole.

34. The magnetic-inductive flow meter according to claim 17, wherein the electrode shaft is embodied as an electrode shaft with a thread.

35. The magnetic-inductive flow meter according to claim 30, wherein the injection-moldable sealing material comprises an elastomer.
